(19) United States
(12) Patent Application Publication
(10) Pub. No.: US 2025/0303496 A1
(43) Pub. Date: Oct. 2, 2025

(54) LASER PROCESSING APPARATUS

(71) Applicant: Via Mechanics, Ltd., Atsugi-shi (JP)

(72) Inventors: Yoshitaka HOSHINA, Atsugi-shi (JP); Takahiro TAKECHI, Atsugi-shi (JP)

(21) Appl. No.: 19/078,718

(22) Filed: Mar. 13, 2025

(30) Foreign Application Priority Data
Mar. 27, 2024 (JP) 2024-050912

(51) Int. Cl. B23K 26/082; B23K 26/06; B23K 26/062; B23K 26/382

(52) U.S. Cl. CPC B23K 26/082; B23K 26/062; B23K 26/0643; B23K 26/382

(57) ABSTRACT

The present invention provides a laser processing apparatus capable of reducing a size of an inclination angel in a scan area and reducing deviation of a processing positional error amount caused by misalignment between a center position of the scan area and a vertically incident position. A table driver and a galvano driver are controlled based on processing position coordinates corrected based on the misalignment amount between the center position of the scan area and the vertically incident position of the laser beam such that the scan area is positioned where the laser beam is vertically incident on the center position of the scan area, and a galvano mirror is positioned such that the laser beam is incident on the corrected processing position coordinates.

### CROSS-REFERENCE TO RELATED APPLICATION

This application claims foreign priority benefits under 35 U.S.C. § 119 to Japanese Patent Application No. 2024-050912 filed on Mar. 27, 2024, the content of which is hereby incorporated by reference in its entirety.

### TECHNICAL FIELD

The present invention relates to a laser processing apparatus for drilling a hole in a printed circuit board, and more specifically relates to a laser processing apparatus for deflecting a laser beam in a two-dimensional direction, irradiating the laser beam onto a printed circuit board via an FO lens, and drilling a hole in the printed circuit board.

### BACKGROUND

As disclosed in, for example, Patent Document 1 (Japanese Patent Application Laid-Open Publication No. 2013-71153) and Patent Document 2 (Japanese Patent Application Laid-Open Publication No. 2020-49531), a laser processing apparatus for drilling a hole in a printed circuit board is configured such that a laser beam emitted from a laser oscillator is deflect by a galvano scanner in a two-dimensional direction and is irradiated onto a printed circuit board, or a workpiece, placed on a table via an Fθ lens. FIG. 1 is a schematic block diagram of a conventional laser processing apparatus. Hereinafter, the conventional laser processing apparatus will be described with reference to FIG. 1.

The conventional laser processing apparatus has a laser oscillator 1 that emits a laser beam, an acousto-optic modulator (e.g., AOM) 2 that splits the laser beam in two directions, one in a processing direction and the other in a non-processing direction, a damper 3 that absorbs the laser beam split in the non-processing direction by the AOM 2, a galvano scanner 4 that deflects the laser beam split in the processing direction by the AOM 2 in a two-dimensional direction, an Fθ lens 5 that focuses the laser beam deflected by the galvano scanner 4 onto a printed circuit board 6, a table 7 on which the printed circuit board 6 is placed, and a table driver 8 that allows the table 7 to move in X and Y directions. Note that the galvano scanner 4 comprises a first galvano mirror 41 positioned around a rotation axis by a first galvano motor 43, and a second galvano mirror 42 positioned around the rotation axis by a second galvano motor 44. Note that the galvano scanner 4 and the Fθ lens 5 are held by a processing head (not shown), and a focal position of the Fθ lens 5 in a height direction can be adjusted by moving a position of the processing head in a Z-axis direction.

A processing region of the printed circuit board 6 is divided into a plurality of scan areas 9 where the laser beam is deflected by the galvano scanner 4, and a drilling process is carried out sequentially for each scan area. Note that a maximum range where the laser beam can be deflected by the galvano scanner 4 is larger than the scan area 9.

Reference sign 10 represents a laser oscillation controller that commands oscillation and attenuation of the laser beam in the laser oscillator 1, reference sign 11 represents an AOM controller that controls an operation of the AOM 2, reference sign 12 represents a galvano controller that controls an operation of the galvano scanner 4, and reference sign 13 represents a table controller that controls a drive operation of the table driver 8. Reference sign 14 represents an overall controller that controls each part of the laser processing apparatus and operation of the entire apparatus. The overall controller is achieved by, for example, a program-controlled processor, and has a storage that stores various information therein. The overall controller 14 has control functions other than those described herein, and is also connected to other blocks not shown.

Based on processing position coordinates input in advance as a program for processing, the overall controller 14 creates and stores table data provided to the table controller 13 for controlling the table driver 8, galvano data provided to the galvano controller 12 for controlling the operation of the galvano scanner 4, laser data provided to the laser oscillation controller 10 for controlling an emitting timing of the laser oscillator 1, and AOM data provided to the AOM controller 11 for controlling the operation of the AOM 2. The overall controller 14 then performs processing by issuing an operation command signal to each controller based on each of the stored data.

More specifically, the overall controller 14 performing controls based on each of the above-described data allows the laser processing apparatus to operate in the following manner. First, the table 7 on which the printed circuit board 6 is placed is moved and positioned such that a center position of the scan area 9 to be processed is aligned with a center axis of the Fθ lens 5. Next, the galvano mirrors 41 and 42 are rotated and positioned in the scan area 9 such that the laser beam is incident on the processing position coordinates. Then, the laser beam is emitted from the laser oscillator 1, is split in the processing direction at the AOM 2, and is focused onto the printed circuit board 6 via the Fθ lens 5 for processing. When processing of one scan area 9 is finished, the center position of the next scan area is positioned so as to be aligned with the center axis of the Fθ lens 5 for sequential processing.

In such a laser processing apparatus, it is known that, as an incident position on the Fθ lens for the laser beam deflected by the galvano scanner 4 moves away from a center of the lens, the laser beam transmitted through the lens and incident on the board is inclined with respect to the center axis line of the lens. As described in, for example, Patent Document 2, it is known that, when a surface of the printed circuit board has minute unevennesses, an inclination of the laser incident on the board causes a positional error in the two-dimensional direction at a processing position. Note that, in addition to surface unevennesses of the board itself, when a surface of the table 7 has minute wavinesses, the printed circuit board 6 placed on the table 7 may also have wavinesses along with the table 7, which may result in a processing positional error.

The above-described laser processing apparatus is designed such that a laser optical axis at a galvano origin position which is a center of a swing angle of the galvano mirror is aligned with the center axis of the Fθ lens 5 to have the laser vertically incident on the center position of the scan area. Thus, in a case where the processing apparatus is assembled as designed, the laser is vertically incident on the center position of the scan area, and is inclined as it moves away from the center. In other words, in a case where the surface of the board has unevennesses, the processing positional error that may occur gradually increases as the distance from the center position increases.

However, it is difficult to assemble the apparatus such that the laser optical axis at the galvano origin position is perfectly aligned with the center axis of the Fθ lens. In other words, it is difficult to assemble the apparatus such that the laser is vertically incident on the center position of the scan area. In addition, misalignment between the center position of the scan area and a position where the laser is vertically incident (hereinafter simply referred to as vertically incident position) causes problems as described below.

FIG. 2 is a graph showing an inclination angle of the laser beam in the scan area when the center position of the scan area and the vertically incident position are in a misaligned state. Here, the inclination angle in the X direction is shown in absolute value, and the same applies to the Y direction. As shown in the graph, in a case where the center position C of the scan area and the vertically incident position V are misaligned, the inclination angle becomes too large at one end “A” of the scan area, and an amount of the processing positional error that may occur on the surface of the board may exceed an allowable value.

In such a case, it is conceivable to simply set the scan area 9 to be smaller to keep the positional error amount within the allowable value, that is, to keep the inclination angle within the allowable value to prevent usage of a range exceeding the allowable value of the end “A” side. However, although setting the scan area 9 to be smaller may allow an increase in the number of scan areas 9 in the entire board 6, an increase in the number of scan areas may cause an increase in the number of table movements, leading to problems such as an increase in processing time required for one board which is not considered adequate.

An object of the present invention is to solve the above-described problems of the conventional technique, and to provide a laser processing apparatus capable of reducing deviation in the size of the inclination angle in the scan area caused by misalignment between the center position of the scan area and the vertically incident position, that is, the amount of processing positional error that may occur, and capable of improving accuracy of a processing hole position without reducing the size of the scan area.

### SUMMARY

In order to solve the above-described problems, the present invention provides a laser processing apparatus configured to perform processing based on processing position coordinates of a pre-stored program. The apparatus includes a laser oscillator configured to oscillate a laser beam, a galvano mirror configured to deflect the laser beam in a two-dimensional direction, an Fθ lens configured to focus the laser beam deflected by the galvano mirror onto a workpiece, a table movable in a horizontal direction and on which the workpiece is placed, a galvano driver configured to rotationally drive the galvano mirror, a galvano controller configured to control the galvano driver, a table driver configured to drive the table, and a table controller configured to control the table driver. The table driver and the galvano driver are controlled based on processing position coordinates corrected based on a misalignment amount between a center position of a scan area and a vertically incident position of the laser beam such that the scan area is positioned at a position where the laser beam is vertically incident on the center position of the scan area, and the galvano mirror is positioned such that the laser beam is incident on the corrected processing position coordinates.

According to the present invention, it is possible to reduce deviation in the size of the inclination angle in the scan area caused by misalignment between the center position of the scan area and the vertically incident position, that is, the amount of processing positional error that may occur, to improve accuracy of the processing hole position.

### DRAWINGS

FIG. 1 is a schematic block diagram of the conventional laser processing apparatus.

FIG. 2 is a graph showing the inclination angle of the laser beam in the scan area when the center position of the scan area and the vertically incident position are in a misaligned state.

FIG. 3 is a schematic block diagram of the laser processing apparatus according to one example of the present invention.

FIG. 4 is a graph for describing a method of measuring a center misalignment amount according to one example of the present invention.

FIG. 5 is an image diagram showing the positional relationship of the scan area before and after correction with respect to the FO lens, according to one example of the present invention.

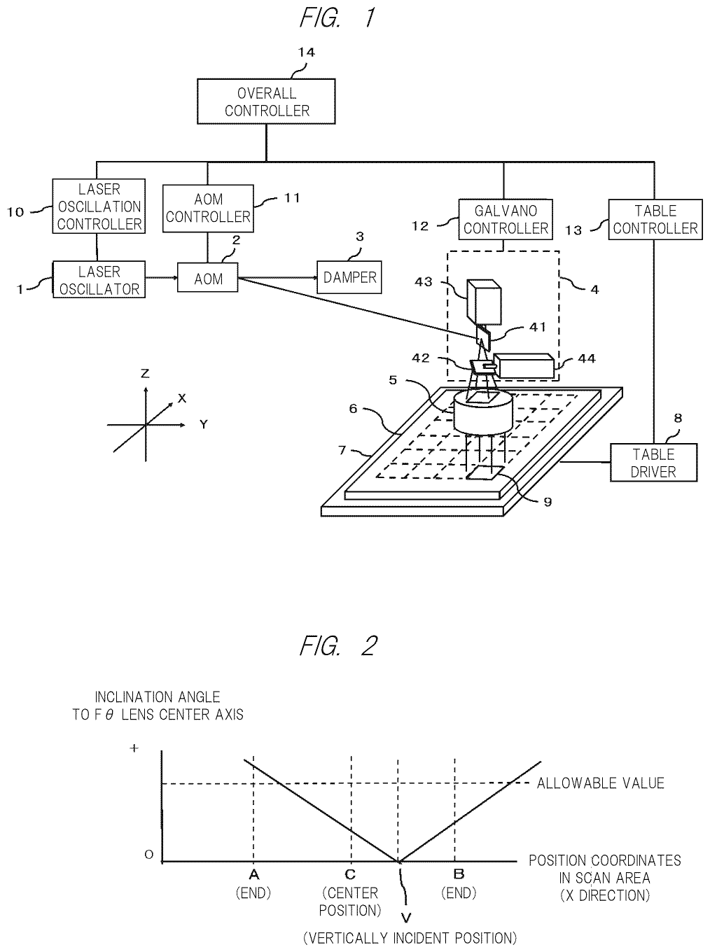

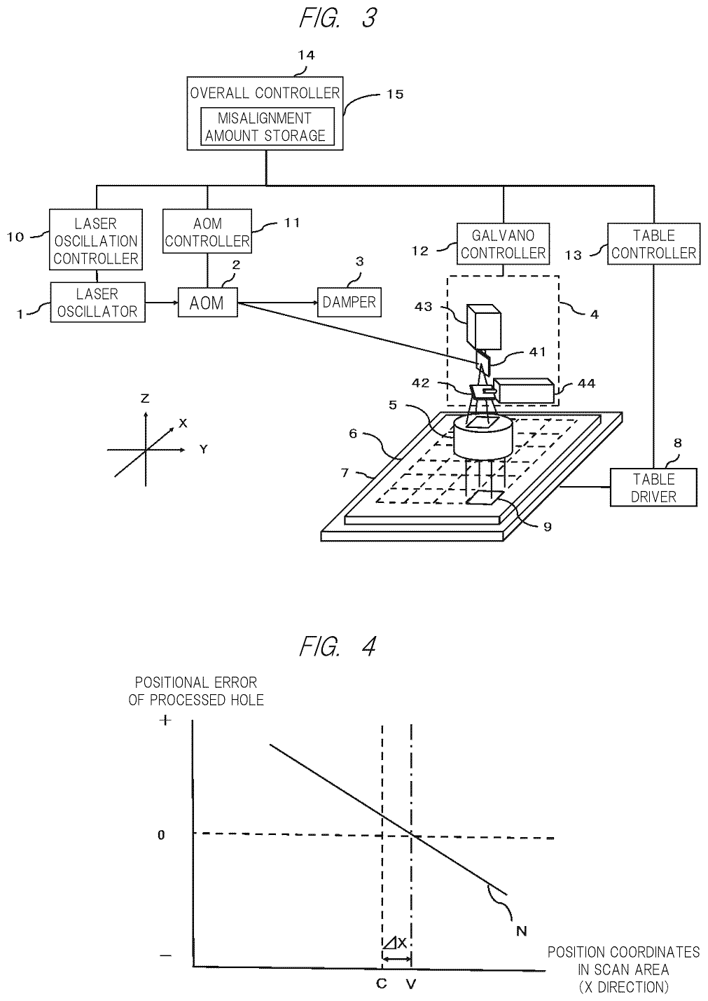

### PREFERRED EMBODIMENTS

Hereinafter, an embodiment of the present invention will be described with reference to the drawings. Note that descriptions of portions that are the same as those of the prior art are omitted as appropriate.

FIG. 3 is a schematic block diagram of the laser processing system according to one example of the present invention. The overall controller 14 comprises a misalignment amount storage 15. The misalignment amount storage 15 stores the misalignment amount (hereinafter also referred to as “center misalignment amount”) in the X and Y directions in the XY coordinates between the center position of the scan area 9 and the vertically incident position.

Next, an operation of the laser processing apparatus according to one example of the present invention will be described. Prior to using the processing apparatus, the center misalignment amount is determined in advance and stored in the misalignment amount storage 15. The center misalignment amount is determined, for example, in the following manner.

First, a flat plate (acrylic plate) for test processing is placed on the table 7. An example of the flat plate for test processing includes an acrylic plate that has no minute surface unevennesses, has no wavinesses along with the table, and has a flat surface when placed on the table. Next, a space between the Fθ lens 5 and a surface of the acrylic plate is adjusted to set the focal position separated from a surface of the acrylic plate by a desired distance in a height direction. Then, test processing is performed based on a test processing program with a plurality of processing position coordinates placed at predetermined intervals on a straight line in the scan area parallel to an X axis and including the center position coordinates of the scan area, and the error amount from the actual processing position at each of the processing position coordinates is measured. Note that the flat plate for test processing may be other than acrylic and, for example, may be a glass plate as long as there are no minute unevennesses on its surface and there are no minute wavinesses on the table. In this manner, the center misalignment amount in the scan area can be determined regardless of any minute wavinesses on the table surface.

FIG. 4 is a graph for describing a method of measuring the center misalignment amount according to one example of the present invention, and shows the processing positional error amount in the X direction after test processing. As shown in the drawing, the vertically incident position V can be defined as a position where the positional error is zero in a straight line (or approximately straight line) N obtained by connecting the error amount at each position. Then, misalignment ΔX between the identified vertically incident position V and the center position C of the scan area can be set as the misalignment amount in the X coordinate. Although the method for obtaining the misalignment amount in the X direction has been described with reference to FIG. 4, the method can be similarly used to obtain the misalignment amount in the Y direction. In this manner, the focal position is not set on the surface of the acrylic plate but is set at a position away from the surface, making it easier to measure the vertically incident position, as the inclination angle with respect to the center axis of the lens is more easily expressed as the positional error of the processed hole in the surface of the acrylic plate.

Next, a processing operation of the laser processing apparatus according to the present invention will be described. The overall controller 14 creates table data, galvano data, and the like based on the corrected processing position coordinates obtained by adding the center misalignment amount stored in the misalignment amount storage to the processing position coordinates input as a program in advance, and stores each of the data. The overall controller 14 then controls each controller according to each data based on the corrected processing position coordinates.

More specifically, the overall controller 14 controls the laser processing apparatus according to the above-described table data and the like created based on the corrected position coordinates to allow the laser processing apparatus to operate in the following manner. First, the table 7 on which the printed circuit board 6 is placed is moved and positioned such that the center position of the scan area 9 to be processed before correction is aligned at a position misaligned by the same amount as the center misalignment amount from the center axis of the Fθ lens. In other words, the center position of the scan area 9 before correction is positioned at the vertically incident position. Note that, in order to position the scan area to be processed, coordinates serving as positioning reference are set in the scan area. The table is moved such that these coordinates serving as reference are positioned at a position misaligned by the same amount as the center misalignment amount such that the center position of the scan area 9 is positioned at the vertically incident position.

Next, the galvano mirrors 41 and 42 are rotated and positioned in the scan area 9 such that the laser beam is incident on the position coordinates misaligned from the processing position coordinates before correction by the same amount as the center misalignment amount. Then, the laser oscillator 1 oscillates the laser and splits it in the processing direction in the AOM 2 such that the laser is focused on the surface of the printed circuit board 6 via the Fθ lens 5 for processing. When processing of one scan area 9 is finished, the laser is moved to the next scan area in the same manner for sequential processing.

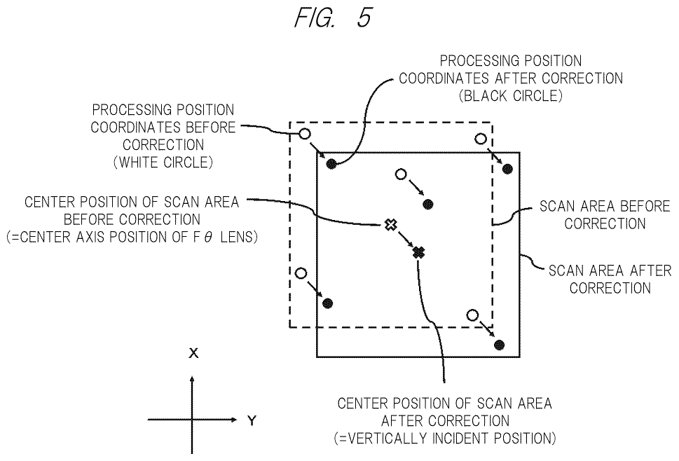

FIG. 5 is an image diagram showing the positional relationship of the scan area before and after correction with respect to the Fθ lens, according to one example of the present invention. White circles represent the processing position coordinates before correction, and black circles represent the processing position coordinates after correction. In addition, white X marks represent the center position of the scan area before correction, and black X marks represent the same position after correction. Further, the broken line box represents the scan area before correction, and the solid line box represents the scan area after correction. As shown in FIG. 5, according to the present invention, the entire scan area can be shifted such that its center is aligned with the vertically incident position. This can reduce deviation of the inclination angle in the scan area, that is, the deviation in the processing positional error amount, and allow the processing position error that may occur by minute unevennesses appearing on the board surface to be kept within the allowable range.

In addition, according to the present invention, even if the positional error amount at the end of the scan area is within the allowable range, the center position of the scan area and each of the processing position coordinates can be corrected to match the position where the laser is vertically incident. This allows the positional error that may occur between the two ends of the scan area to be equal, further improving processing quality.

What is claimed is:

1. A laser processing apparatus configured to perform processing based on processing position coordinates of a pre-stored program, the laser processing apparatus comprising:
a laser oscillator configured to oscillate a laser beam;
a galvano mirror configured to deflect the laser beam in a two-dimensional direction;
an Fθ lens configured to focus the laser beam deflected by the galvano mirror onto a workpiece;
a table movable in a horizontal direction and on which the workpiece is placed;
a galvano driver configured to rotationally drive the galvano mirror;
a galvano controller configured to control the galvano driver;
a table driver configured to drive the table; and
a table controller configured to control the table driver,
wherein the table driver and the galvano driver are controlled based on processing position coordinates corrected based on a misalignment amount between a center position of a scan area and a vertically incident position of the laser beam, such that:
the scan area is positioned at a position where the laser beam is vertically incident on the center position of the scan area; and
a galvano mirror is positioned such that the laser beam is incident on the corrected processing position coordinates.

2. The laser processing apparatus according to claim 1,
wherein the misalignment amount is determined by performing test processing with a focal position of the FO lens separated from a surface of a flat plate for test processing by a desired distance in a height direction, and
wherein the flat plate is made of material where no unevennesses occur on its surface when placed on the table.
